(19) United States
(12) Patent Application Publication
(10) Pub. No.: US 2003/0101020 A1
(43) Pub. Date: May 29, 2003

(54) Devices connected to fiber channels and margin test method for the devices, and method for specifying problems in system having devices connected to fiber channels

(75) Inventor: Hiromi Matsushige, Hiratsuka (JP)

Correspondence Address: HOGAN & HARTSON L.L.P., 500 S. GRAND AVENUE, SUITE 1900, LOS ANGELES, CA, 90071-2611, US

(73) Assignee: HITACHI, LTD.

(21) Appl. No.: 10/217,496

(22) Filed: Aug. 12, 2002

(30) Foreign Application Priority Data
Nov. 29, 2001 (JP) 2001-363562

(51) Int. Cl. G06F 15/00; G21C 17/00

(52) U.S. Cl. 702/185

(57) ABSTRACT

A plurality of electronic devices such as magnetic disk devices may be connected to a fiber channel arbitrated loop. Each of the electronic device includes a port bypass circuit that selectively separates the electronic device from the fiber channel arbitrated loop, a margin test circuit added to an input/output circuit of the electronic device connected to the port bypass circuit, and a signal line that provides a control signal to the margin text circuit from outside of the electronic device. The electronic device is selectively connected to and operated on the fiber channel arbitrated loop while the margin test circuit is made functional by the control signal to generate an error.

### 1. FIELD OF THE INVENTION

The present invention relates to a technology for testing electronic devices (hereinafter called “devices”) connected to fiber channel arbitrator loops (hereinafter abbreviated “FC-AL” when appropriate), and particularly to a margin test for device interfaces.

### 2. DESCRIPTION OF RELATED ART

As access speed of magnetic disk devices has become faster, a faster speed has also been demanded of system interfaces of host devices that perform input/output processing with magnetic disk devices, and the fiber channel arbitrator loop technology has consequently come into use.

The FC-AL technology is a technology that eliminates data skews in parallel transfer interfaces by transferring data serially to magnetic disk devices through optical cables, copper wire and/or other communication lines, and thereby makes a high-speed data transfer possible.

Here, a skew refers to a lag in transmission time between arbitrary signals on an interface cable in parallel data transfer. In the SCSI standard, IDE standard and other parallel transfer interfaces, a difference in the transmission time sometimes occurs between data bus signals (DB(0)-DB(7)).

In conventional interfaces for magnetic disk devices, SCSI or IDE, both of which transfer data in parallel, was used. The FC-AL is an upper-level protocol that includes SCSI and IDE standards.

The FC-AL has high data transfer capability, wide bandwidth and flexible connectivity, and is therefore anticipated to hold promise in functioning as various types of interfaces. However, not enough countermeasures are in place for loop failures when there are numerous devices, for example, 64 to 256 or more magnetic disk devices or other devices, connected to the FC-AL.

A system comprising a group of devices connected to an FC-AL may contain failures that cannot be detected by the devices connected within the loop.

For example, when replacing a magnetic disk device or other device connected to the loop, the properties of an FC signal can deteriorate depending on the combination of particular magnetic disk devices and particular implementation addresses. Or, a failure of a device other than the magnetic disk device in which “a failure has occurred” can lead to a loop-wide failure. Or, a problem can occur in which the magnetic disk device that caused the FC loop failure cannot be identified.

The types of failures include the following: 1) a magnetic disk device intermittently adds false signals in a process beginning with receiving an FC signal and ending by sending it; 2) a frame count error occurs due to data loss; 3) an error in the control of the FC occurs after the required data is sent; and other types.

A disk array system, which is an example of a system with an FC-AL, executes a recovery operation based on a phenomenon that occurred in a magnetic disk device connected to the loop. The phenomenon can be a failure in the magnetic disk device itself, a fault error that is detected by an error sensor device within the magnetic disk device, or that the magnetic disk device must be replaced.

When the number of recovery operations exceeds a predetermined threshold value, a host computer connected in an accessible manner to the disk array system normally deems that a failure has occurred in the loop and blocks the loop.

When a host computer blocks an FC loop, often an error sensor circuit of a magnetic disk drive connected to the loop is outputting a fault error. However, it is difficult for the host computer to identify where the failure has occurred due to the following characteristics in failures that occur in the loop.

The magnetic disk device that sends the wrong data cannot detect its own error, and instead a normal magnetic disk device positioned downstream in the loop intermittently detects the fault error.

Consequently, failures that occur within a loop are characterized by the following: a) the error sensor circuit of a magnetic disk device different from the magnetic disk device in which a failure has occurred detects the “occurrence of error”; b) an error in a magnetic disk drive develops into a loop-wide failure; and c) there is no means to detect which magnetic disk drive of a plurality of magnetic disk drives connected to the loop sent the wrong data and caused a failure in the FC loop, which therefore makes it extremely difficult to ascertain the cause of the error.

As a result, due to the fact that identifying the location of the failure that caused the FC loop to be blocked was difficult, when a host computer goes through a recovery operation and notifies the maintenance center that a certain FC loop has been blocked, it has been difficult for the maintenance staff to quickly and accurately identify the failure location and recovery has been a time-consuming process.

More specifically, it is possible to determine a magnetic disk drive with the failure in a loop in which the failure occurred by utilizing a hot swapping function of a magnetic disk drive that is suspected of having a failure to physically separate it from the loop and thereby bypass it, and by repeating a write/read test operation using the loop. However, because the frequency of failures in each magnetic disk drive is low, the checking process after the separation requires a long monitoring.

A long time is especially required to reproduce a failure when an error that occurs in a write/read interface of a magnetic disk drive comprising a disk array system causes a recovery operation by the host computer connected to the disk array system to be activated, and when the number of times the operation is repeated exceeds the limit, and thereby causes the loop containing the problematic magnetic disk drive to be blocked.

In conventional FC-AL systems, when failures occurred that may require a replacement of a magnetic disk drive or other changes in the system, there was no means to quickly find where the failures occurred due to the characteristics described above, so that the work efficiency was low in determining the failure within a FC-AL system and in recovery from the failure.

### SUMMARY OF THE INVENTION

The present invention relates to a margin testing device and a margin measuring method for interface functions of various devices in an FC loop that contains devices such as magnetic disk drives.

The present invention also relates to facilitating detection of failures in various devices and to enable, by a device for identifying the location of the failures, quick recovery from failures in an FC loop having devices.

In accordance with one embodiment of the present invention, a margin testing device that sets a more stringent operation margin for an interface circuit of a device connected to a loop by applying an offset voltage to a signal input/output stage of the device is assembled into a system having the loop.

The margin testing device and a bypass circuit that separates from the loop a device connected to the loop are harmonized in order to provide the system having the loop with a function to recognize and separate a device with a low margin.

In accordance with one embodiment of the present invention, there is provided a function that executes a margin test and quickly identifies and separates the location of the failure based on system log information that indicates whether a loop failure has occurred.

In accordance with another embodiment of the present invention, there is provided a function that executes a margin test to examine devices connected to the loop, when the power is turned on in the system having the loop.

When the test reveals a failure in one of the devices in the loop, there is also provided a function to separate the device from a circuit of the loop.

The separated device may have a hot swapping function and therefore can be replaced without turning off the power to the system.

In accordance with another embodiment of the present invention, a device is provided that allows parameters for the margin testing device to be set from outside the system having the loop.

In accordance with another embodiment of the present invention, a method for controlling a margin testing device comprises: a step of inputting a test signal into a loop; a step of making the margin more stringent; a step of detecting the error rate of a device; a step of selecting one or two devices from among a plurality of devices connected to the loop; a step of changing selection of the one or two devices to be connected to the loop upstream or downstream with respect to data transmission in the loop; a step of presuming which device has a failure, or a step of identifying the device with a falling margin; and a step of separating the presumed or identified device from the loop.

Other features and advantages of the invention will be apparent from the following detailed description, taken in conjunction with the accompanying drawings that illustrate, by way of example, various features of embodiments of the invention.

### BRIEF DESCRIPTION OF DRAWINGS

FIG. 1 shows an example of the structure of key parts of a system with a fiber channel loop to which the present invention is applied.

FIG. 2 shows a partially enlarged view of FIG. 1, which indicate an example of the structure when no margin tests are executed in accordance with a first embodiment of the present invention.

FIG. 3 shows a partially enlarged view of FIG. 1, which indicates an example of the structure when a margin test is executed in accordance with the first embodiment of the present invention.

FIG. 4 shows a diagram illustrating an example of the timing and margin to take in fiber channel signal in a data recovery circuit.

FIG. 5 shows a diagram indicating the relationship between offset voltage and bite error rates of devices.

FIG. 6 shows a diagram indicating a second embodiment of the present invention.

FIG. 7 shows a flowchart of a failure recovery process in a system in accordance with an embodiment of the present invention.

FIGS. 8(a) and 8(b) show diagrams illustrating a margin test on through circuits of magnetic disk devices in routine 1 of FIG. 7.

FIGS. 9(a) and (b) show diagrams illustrating a margin test on write circuits of magnetic disk devices in routine 2 of FIG. 7.

FIGS. 10(a) and 10(b) show diagrams illustrating a margin test on read circuits of magnetic disk devices in routine 3 of FIG. 7.

### EMBODIMENTS OF THE PRESENT INVENTION

An embodiment of a FC-AL system to which the present invention has been applied is described below with reference to the accompanying drawings.

<Overall Structure>

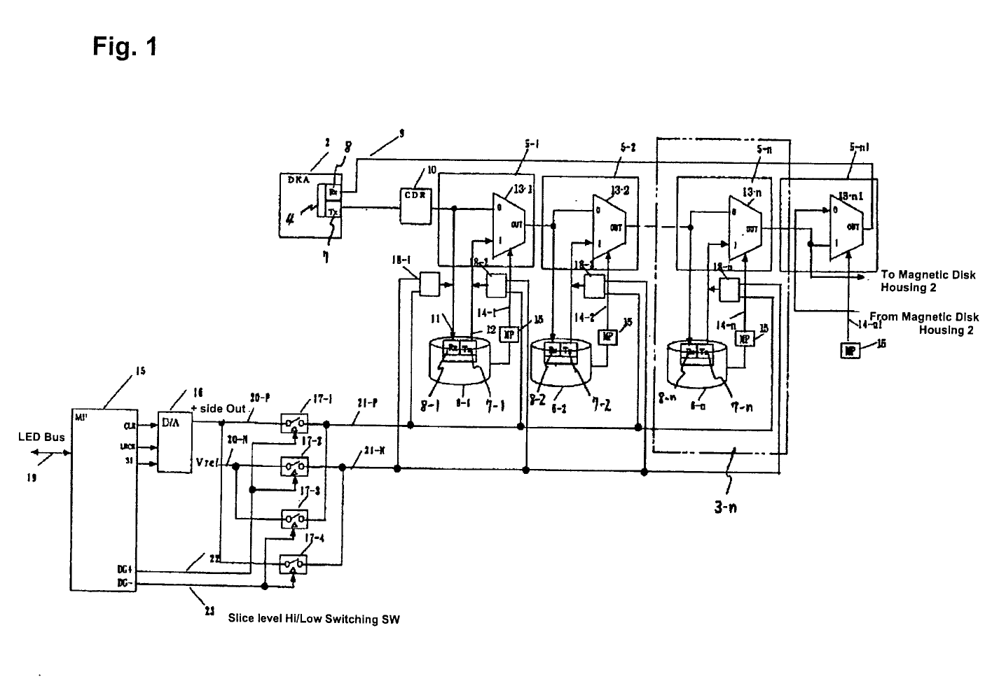

FIG. 1 indicates the overall structure of the FC-AL system.

A host device 1, omitted from drawings, is connected to a disk adapter 2 (hereinafter called the “DKA 2”) in an accessible manner and controls and governs the latter. The DKA 2 positioned under the host device 1 has a port 4, whose purpose is to connect with a fiber channel loop, and which connects via a clock/data recovery circuit 10 (hereinafter called the “CDR circuit 10”) with port bypass circuits 5-1-5-n1 in a loop by a fiber channel communication line 9. It is noted that the host device 1 and the DKA 2 can be connected by a fiber channel.

The port bypass circuits 5-1-5-n are a part of a circuit device that selects and controls whether a signal transmitted through the fiber channel communication line 9 should be input from/output to magnetic disk devices 6-1-6-n that each of the port bypass circuits 5-1-5-n respectively controls, or the magnetic disk devices 6-1-6-n should be bypassed in the fiber channel loop.

Each of the magnetic disk devices 6-1-6-n may have a plurality of magnetic disk devices stored in one disk housing 3-n, a plurality of bypass circuits (omitted from drawings) that has a function to select whether the plurality of magnetic disk devices should be connected to or separated from a fiber channel loop within the housing, and two sets of a port 4 (omitted from drawings) that connect the plurality of magnetic disk drives with a fiber channel loop outside the housing. Here, one set of the port 4 has a transmitter amplifying section 7 (Tx) and a receiver amplifying section 8 (Rx).

Alternatively, the DKA 2, the port bypass circuits 5-1-5-n1, and the magnetic disk devices 6-1-6-n governed by the port bypass circuits 5-1-5-n1 respectively can all be stored in one housing; or each port bypass circuit 5-i and a magnetic disk device 6-i that it governs can be stored in one housing 3-i (omitted from drawings).

In the system shown in FIG. 1, each of the magnetic disk devices 6-1-6-n can be separated from the FC loop, since the port bypass circuits 5-1-5-n are added to the magnetic disk devices 6-1-6-n, respectively. The port bypass circuit 5-n1 has a function to turn on/off a loop connection with another housing 2 (not shown) that stores other magnetic disk devices.

For example, the fiber channel communication line 9 can be connected to the FC loop in the order of the DKA2, the magnetic disk device #15 (here, #15 refers to a number that indicates a physically implemented position), #13, #11, #9 . . . #1, #0, #2, #4, #6 . . . #14, the next magnetic disk device housing 2 or return to the DKA 2.

Each of the magnetic disk devices 6-1-6-n, as well as the DKA 2, has a port with the transmitter amplifying section (Tx) 7 and the receiver amplifying section (Rx) 8 and, connects with the fiber channel communication line 9 via the respective port bypass circuit 5-1-5-n1. An FC signal sent from the transmitter amplifying section (Tx) 7 of the DKA 2 travels through the CDR 10, each of the port bypass circuits and each one of the ports thereof and ultimately returns to the receiver amplifying section (Rx) 8 of the DKA 2.

An FC signal 11 that is provided as an input via an FC signal line of the receiver amplifying section Rx 8-1 of the magnetic disk device 6-1 is sent from the transmitter amplifying section Tx 7-1 of the same magnetic disk device 6-1 and is received by the port bypass circuit 5-1 via a receiving FC signal line 12. Along this path are voltage applying circuits 18-1 and 18-2 equipped for a margin test and margin measurement of the FC loop interface.

The magnetic disk device 6-1 has two voltage applying circuits so that it can apply voltage to its receiving side as well.

Normally, a coaxial cable is connected between a DKA and the port bypass circuit at a first stage in order to allow FC signals to be sent even at long distance. A clock and data recovery (CDR) circuit or a re-timer circuit is provided in the first stage input of the port bypass circuit, as a compensation device in the event the quality of an FC signal deteriorates as a result of a long distance transmission using such a coaxial cable.

The CDR circuit or the re-timer circuit reforms by its internal PLL (phase lock loop) circuit the FC signal sent through the cable and transfers it to a next multiplexer 13-1 down the line. When a voltage is applied to the input of the CDR circuit, for example, the performance of the PLL circuit within the CDR circuit is monitored.

The bit cycle lag of the FC signal resulting from the voltage applied in a prior (upstream) stage of the CDR circuit is reformed in the PLL circuit within the CDR circuit and thereby becomes corrected to the bit cycle of a normal FC signal. For this reason, a voltage must be applied by the voltage applying circuit 18-2 to the signal line downstream of the CDR circuit 10 in order to test the reception breakdown strength of the magnetic disk device 6-1. The voltage applying circuit 18-2 tests the reception breakdown strength of the next magnetic disk device 6-2 via the multiplexer 13-1.

Each of the voltage applying circuits 18-1-18-n is controlled by a respective microprocessor 15, which receives commands through communication via an LED bus cable connected between the host device 1 (omitted from drawings) and each of the microprocessors 15.

<Control of the Voltage Applying Circuits>

For example, when a system's power is turned on, and the host device sends to each of the microprocessors 15 via an LED bus cable 19 a threshold level Ldet setting information to be used in margin measurement. The setting information is written on a register of each microprocessor 15.

The threshold level Ldet is sent to a digital/analog (D/A) converter 16, where it is converted from a digital threshold level Ldet to an analog threshold level Ldet 20-P, and is sent to analog switch circuits 17-1 and 17-4.

A reference voltage Vref 20-N that is generated in a resistance dividing circuit or other circuits (omitted from drawings) is applied to input terminals of the analog switch circuits 17-2 and 17-3.

The analog switch circuits 17-1 and 17-2 are on/off controlled by a control signal DG+ 22 from the microprocessor 15, while the analog switch circuits 17-3 and 17-4 are on/off controlled by a control signal DG−23 from the microprocessor 15.

When the control signal DG+ 22 is on, the analog switch circuit 17-1 provides the analog threshold level Ldet signal from the D/A converter 16 to an output signal line 21-P, while the analog switch circuit 17-2 provides the value of a reference voltage Vref to an output signal line 21-N of the analog switch circuit 17-2. When the control signal DG+ 22 is off, the analog switch circuits 17-1 and 17-2 are in an off state, so that neither the analog threshold level Ldet nor the reference voltage Vref is sent to the output signal lines 21-P or 21-N, respectively.

The analog switch circuits 17-3 and 17-4 are on/off controlled by a control signal DG−23 from the microprocessor 15. When the control signal DG−23 is on, the analog switch circuit 17-3 provides the reference voltage Vref signal to the output signal line 21-P of the analog switch circuit 17-3, while the analog switch circuit 17-4 provides the analog threshold level Ldet signal from the D/A converter 16 to the output signal line 21-N.

When the control signal DG−23 is off, the analog switch circuits 17-3 and 17-4 are in an off state, so that neither the reference voltage Vref signal nor the analog threshold level Ldet signal is sent to the output signal lines 21-P or 21-N, respectively.

When the control signal DG+ 22 and the control signal DG−23 are off, all of the analog circuits 17-1-17-4 are in an off state; consequently, the output signal line 21-P of the analog switch circuits 17-1 and 17-3 and the output signal line 21-N of the analog switch circuits 17-2 and 17-4 each carries a bias voltage set in the receiver amplifier of each of the port bypass circuits 5-1-5-n.

<When the Voltage Applying Circuits Are Made Not to Function>

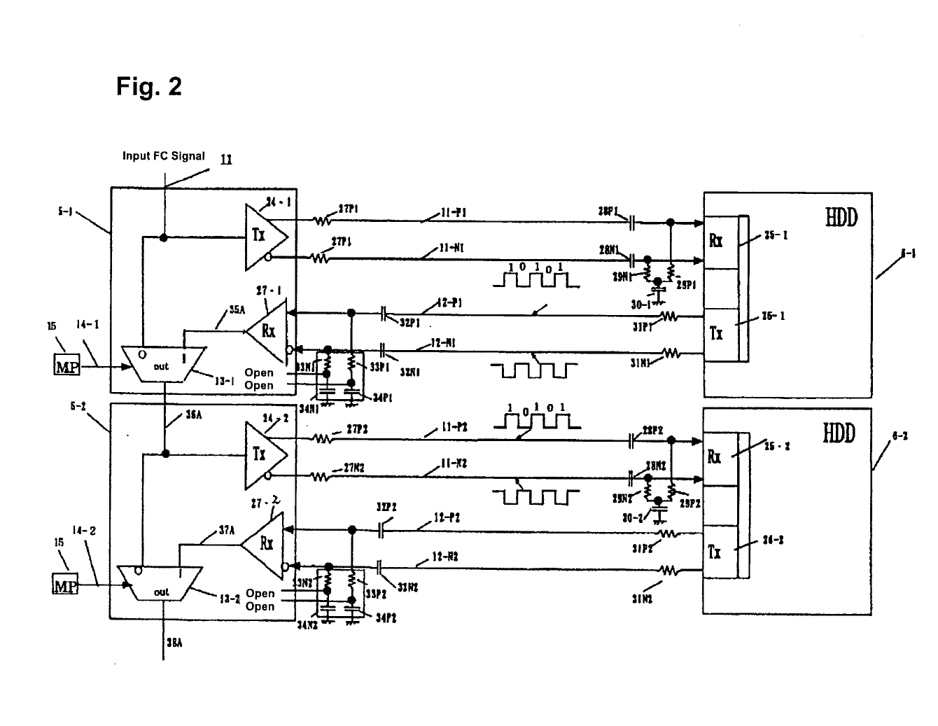

FIG. 2 is an enlarged view of the port bypass circuits 5-1-5-2 and magnetic disk devices 6-1-6-2 in FIG. 1 when the voltage applying circuits 18-1-18-n are made not to function. The fiber channel (FC) signal 11, which is provided as an input via the host device 1, e.g. a host computer or a server, and the DKA 2, is sent to the transmitter amplifying section (Tx) 24-1 and an input terminal 0 of the multiplexer 13-1 of the port bypass circuit 5-1. The Tx 24-1 has a built-in differential amplifier, which compares positive and negative parts of an FC signal, and a transmitter; the FC signal 11 that was provided as an input is waveform-shaped by these and is sent to the magnetic disk device 6-1 via impedance-matched signal lines 11-P1 and 11-N1.

If the magnetic disk device 6-1 does not correspond to a physical address (AL-PA) at which data writing or reading is to be done, a PLL circuit, omitted from drawings, that is built-in inside the magnetic disk device 6-1 discriminates the data contained in the FC signals received by a receiver amplifying section 25-1. Subsequently, the FC signals are converted from 10 bytes to 8 bytes by a 10B/8B conversion circuit, and 10B/8B conversion code errors, omissions of FC signal and other Loss Sync error are detected by an FC signal error sensor circuit, which is made up of a Loss Sync sensor circuit, etc.

The parts where the errors occurred within the frames of the FC signal in which errors were detected are replaced with IDLE signals or ARBx signals. Then, the FC signal 11 is converted from 8 bytes to 10 bytes by an 8B/10B conversion circuit and is provided as an output signal by a transmitter amplifying section 26-1 on signal lines 12-P1 and 12-N1. The signal is transferred to a receiver amplifying section 27-1 of the port bypass circuit 5-1 via the signal lines 12-P1 and 12-N1.

The same thing occurs with the magnetic disk device 6-2.

A differential signal transmission path is formed between the Tx 24-1 of the port bypass circuit 5-1 and the receiver amplifying section (Rx) 25-1 of the magnetic disk device 6-1, and between the Tx 26-1 of the magnetic disk device 6-1 and the Rx 27-1 of the port bypass circuit 5-1.

To control impedance, the FC differential signal transmission path is equipped with transmitter side damping resistors 31P1 and 31N1 on the transmission side of the magnetic disk device 6-1, and with direct current (DC) component cutting capacitors 32P1 and 32N1 and receiving side terminating resistors 33P1 and 33N1 for the port bypass circuit 5-1 on the input terminals of the receiver amplifying section 27-1 on the receiving side.

Each of the terminating resistors 33P1 and 33N1 is connected to the ground via AC coupling capacitors 34P1 and 34N1, respectively, and these together form an integration circuit.

The same applies to the input part of the receiver amplifying section 25-1 of the magnetic disk device 6-1. In other words, receiver side terminating resistors 29N1 and 29P1 and AC coupling capacitor 30-1 form an integration circuit.

In the FC differential signal transmission path described above, the output line 21-P from the analog switch circuits 17-1 and 17-3 in FIG. 1 is connected between the terminating resistor 33P1 and the capacitor 34P1 (open) of the positive FC signal line 12-P1.

In the meantime, the output line 21-N from the analog switch circuits 17-2 and 17-4 is connected between the terminating resistor 33N1 and the capacitor 34N1 (open) of the negative FC signal line.

When the magnetic disk device 6-1 is connected to a platter substrate and to an FC loop and is ready to operate mutually with one another, the control signals DG+ 22 and DG−23 that are provided as outputs from the microprocessor 15 (FIG. 1) are in an off state The positive FC differential signal line 12-P and the negative FC differential signal line 12-N are biased to the same potential by a bias voltage generated within the Rx 27-1 of the port bypass circuit 5-1.

The FC differential signals 12-P1 and 12-N1 that were transferred from the magnetic disk device 6-1 are converted from analog signals into a digital signal (an FC signal 35A) by the Rx 27-1 of the port bypass circuit 5-1; the FC signal 35A is then provided as an input to an input terminal I of the multiplexer 13-1.

The multiplexer 13-1 is controlled by an SEL control signal 14-1 that comes from the microprocessor circuit 15.

When the SEL control signal 14-1 is turned off, the magnetic disk device 6-1 is bypassed, and the multiplexer 13-1 sends the input FC signal 11 as an output signal (out) 36A to the next port bypass circuit 5-2.

When the magnetic disk device 6-1 is not installed or when an installed magnetic disk device cannot operate mutually with the FC loop in a functional manner, the multiplexer 13-1 of the port bypass circuit 5-1 connected to the magnetic disk device turns off the SEL control signal 14-1.

When the SEL control signal 14-1 is turned on, the input FC signal 11 is sent from the TX 24-1 and travels through the magnetic disk device 6-1's port comprising the Rx 25-1 and the Tx 26-1, and the FC differential signals 12-P1 and 12-N1 that return are selected by the multiplexer 13-1. The output signal 36A from the multiplexer 13-1 is sent to the port bypass circuit 5-2, which is the next one downstream in the FC, via the FC loop.

The multiplexer 13-i's output signal 36A that is received by the port bypass circuit 5-2 is divided into two parts, and one signal part is sent to the Tx 24-2 of the port bypass circuit 5-2 and the other is sent to the input terminal 0 of the multiplexer 13-2.

Due to the fact that signals are sent in this manner, FC differential signals 11-P2 and 11-N2, which are outputs from the Tx 24-2, have the same cycle data pattern as the FC differential signals 12-P1 and 12-N1, which are received by the Rx 27-1 of the port bypass circuit 5-1. In this way, a so-called daisy chain connection, i.e., the FC differential signals 11-P2 and 11-N2 are transferred to the Rx 25-2 of a different magnetic disk device, is made possible, but in the event of a failure, the magnetic disk device with the failure can be bypassed by cutting it off from the loop.

<First Embodiment>

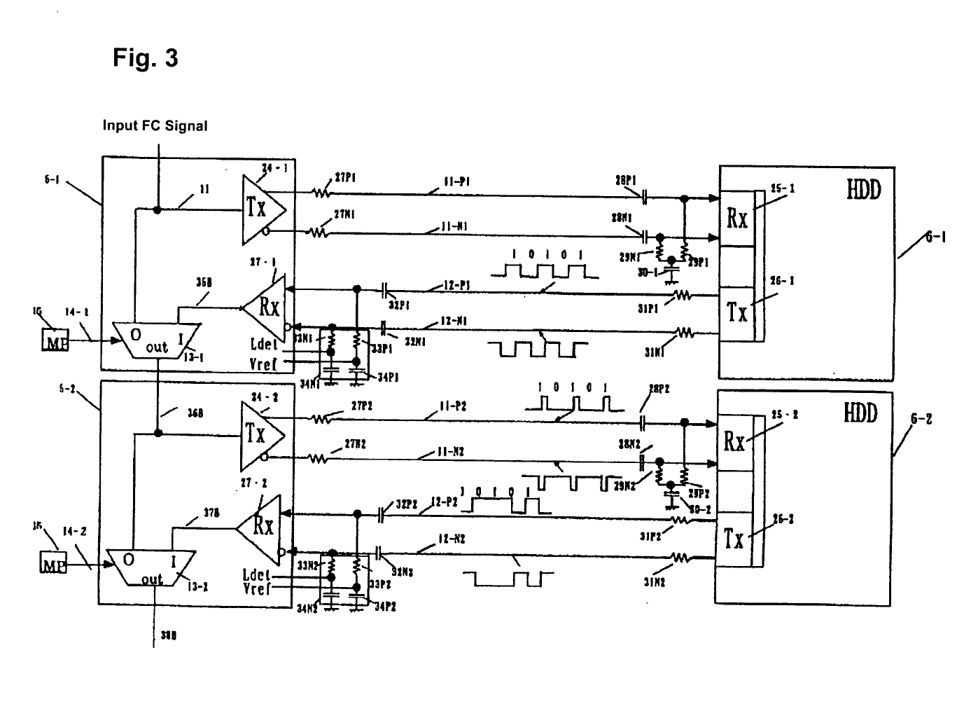

FIG. 3 indicates a circuit diagram when a ΔV offset voltage is provided between FC differential signals by applying a reference voltage Vref to a positive FC signal 12-PI and applying a threshold level Ldet voltage to a negative FC signal line 12-N1 of an Rx 27-1 of a port bypass circuit 5-1. This is done on every port bypass circuit in order to perform a margin test on interfaces of magnetic disk devices or other devices connected to the loop to identify the location of failure in the event a failure occurs, 1) when the system's power is turned on, or 2) when a failure occurs within an FC loop.

In FIG. 3, parts that are numbered as they were in FIG. 2 have already been described in FIG. 2. In FIG. 3, an input FC signal 11 is split into two parts, and one part is sent to a Tx 24-1 and the other part is sent to a multiplexer 13-1. FC differential signals 11-P1 and 11-N1 that are sent from the Tx 24-1 are sent to an Rx 25-1 of a magnetic disk device 6-1.

If the magnetic disk device 6-1 is not the target device, the FC differential signals 11-P1 and 11-N1 that are sent to the magnetic disk device 6-1 are data-discriminated in a PLL circuit built-in inside the magnetic disk drive 6-1. Subsequently, the FC signals are converted from 10 bytes to 8 bytes by a 10B/8B conversion circuit; and 10B/8B conversion code errors, omission of FC signals and other Loss Sync errors are detected by an FC signal error sensor circuit, which is made up of a Loss Sync sensor circuit, etc. The parts where the errors occurred within the frames of the FC signal on which errors were detected are replaced with IDLE signals or ARBx signals. Next, the FC signals are converted from 8 bytes to 10 bytes by an 8B/10B conversion circuit and are provided as output signals by a transmitter amplifying section. They are then sent back via a Tx 26-1 to the Rx 27-1 of the port bypass circuit 5-1 as FC differential signals 12-PI and 12-N1.

If the magnetic disk device 6-1 is the target device, and if there is an IDLE signal or an ARBx signal in a frame of the FC signal when the magnetic disk device 6-1 tries to write, the magnetic disk device 6-1 detects a fault error and reports it to the host device 1 (omitted from drawings). When this happens, the FC signal is sent back via the Tx 26-1 to the Rx 27-1 of the port bypass circuit 5-1 as the FC differential signals 12-P1 and 12-N1.

The positive FC differential signal 12-P1, which travels along the FC signal transmission path from the Tx 26-1 to the Rx 27-1 of the port bypass circuit 5-1 via a transmitting side damping resistor 31P1 and a DC component cutting capacitor 32P1, is terminated by a receiving side terminating resistor 33P1 and provided as an input to one of the input terminals of the Rx 27-1.

In the meantime, the negative FC differential signal 12-N1, which travels via a transmitting side damping resistor 31N1 and a DC component cutting capacitor 32N1, is terminated by a receiving side terminating resistor 33N1 and provided as an input to the other input terminal of the Rx 27-1.

When a control signal DG+ 22 is turned on and a control signal DG−23 is turned off, where both are sent from a microprocessor 15 in FIG. 1, the reference voltage Vref is provided as the positive FC differential signal 12-P1 from a signal line 21-N (FIG. 1) via the terminating resistor 33P1; while the threshold level Ldet that has been offset by ΔV against the reference voltage Vref is provided as the negative FC differential signal 12-N1 from a signal line 21-P (FIG. 1) via the terminating resistor 33N1.

Conversely, when the control signal DG+ 22 is turned off and the control signal DG−23 is turned on, where both are sent from the microprocessor 15 in FIG. 1, the threshold level Ldet that has been offset by ΔV against the reference voltage Vref is provided as the positive FC differential signal 12-P1 from the signal line 21-N via the terminating resistor 33P1; while the reference voltage Vref is provided as the negative FC differential signal 12-N1 from the reference voltage signal line 21-P via the terminating resistor 33N1.

When a predetermined DC offset voltage ΔV is applied between the FC differential signals at the terminating resistors 33P1 and 33N1, the FC differential signals 12-P1 and 12-N1 are biased.

The biased FC differential signals 12-P1 and 12-N1 are converted from analog to digital FC signals by the Rx 27-1. The cycle of data “1”, which is a logical signal, becomes narrower, so that the cycle of data “0” becomes wider (see signal waveforms for 11-P2 and 11-N2 in FIG. 3) relative to the DC offset voltage ΔV that was applied. In other words, the duty ratio of digital signals that are transmitted through the FC-AL are modulated to make the cycle of the data “0” or “1” narrower or wider.

The FC differential signals that have been thus modulated are provided as an output from the Rx 27-1 in the form of a signal 35B and are provided as an input into the input terminal I of the multiplexer 13-1.

The multiplexer 13-1 is controlled by the microprocessor 15 through an SEL control signal 14-1; when the SEL control signal 14-1 is turned on, the multiplexer 13-1 selects the output signal of the Rx 27-1, and an FC signal 36B is provided to a next port bypass circuit 5-2 by the multiplexer 13-1.

In the port bypass circuit 5-2, the FC signal 36B is divided, and one is sent to a Tx 24-2 and the other is sent to an 0 terminal of a multiplexer 13-2.

FC differential output signals 11-P2 and 11-N2, in which the cycle of the data signal “1” has become narrower and the cycle of data “0” has become wider, from the Tx 24-2 are sent to an Rx 25-2 of a magnetic disk device 6-2 via damping resistors 27P2 and 27N2 and DC component cutting capacitors 28P2 and 28N2, all along an FC signal transmission path that has been impedance-matched.

In the Rx 25-2, the FC differential signals 11-P2 and 11-N2 are converted from analog FC signals into digital FC signals.

The FC signals, which have been converted into digital values and whose cycle of the data signal “1” has become narrower while their cycle of data “0” has become wider, are restored by a data cycle recovery circuit and an error sensor circuit with a built-in PLL circuit (omitted from drawings), which are within the magnetic disk device 6-2, to become similar to the FC differential signals 12-P1 and 12-N1 to which ΔV offset voltage was not applied, and are sent back to the Rx 27-2 via a Tx 26-2. This is the normal operation of a data recovery circuit.

Similarly in the Rx 27-2, a reference voltage Vref from a signal line 21-N is provided via a terminating resistor 33P2 as the positive FC differential signal 12-P2, while a threshold level Ldet that has been offset by ΔV against the reference voltage Vref is provided from a threshold level signal line 21-P via a terminating resistor 33N2 as the negative FC differential signal 12-N2.

A predetermined DC offset voltage ΔV is applied between the FC differential signals at the terminating resistors 33P2 and 33N2. With this, the FC differential signals 12-P2 and 12-N2 are converted from analog to digital FC signals by the Rx 27-2.

An FC signal 37B, whose cycle of the data signal “1” has become narrower and whose cycle of data “0” has become wider consequently relative to the DC offset voltage ΔV, is output from the Rx 27-2 and input into an input terminal I of a multiplexer 13-2.

The multiplexer 13-2 is controlled by an SEL control signal 14-2; when the SEL control signal 14-2 is turned on, the multiplexer 13-2 selects the output signal of the Rx 27-2, and provides an FC signal 38B to the next port bypass circuit.

<Error Detection>

Next, we will consider a situation in which the loop operation margin is small in an FC-AL, including FC signal transmission paths, magnetic disk devices and other devices connected to the loop.

In this situation, when the FC differential signals 11-P2 and 11-N2, both of whose cycle of data “1” has become narrower, are received, the PLL circuit within the magnetic disk device 6-2 connected to the FC loop discriminates the data. Subsequently, the FC differential signals are converted from 10 bytes to 8 bytes by a 10B/18B conversion circuit; and whether there are any 10B/8B conversion code errors, omissions in FC signals and other Loss Sync errors detected by an FC signal error sensor circuit, which is made up of a Loss Sync sensor circuit, etc., is tested.

When an error is found in an FC signal, the part in the frame of the FC signal where the error occurred is replaced by an IDLE signal or an ARBx signal. Next, the FC signals are converted from 8 bytes to 10 bytes by an 8B/10B conversion circuit and are provided as transmitter amplifier output signals on signal lines 12-P2 and 12-N2.

In other words, the magnetic disk device 6-2 transfers to a plurality of magnetic disk devices (6-3, 6-4 . . . ) and other devices connected downstream in the FC loop from the transmitter amplifying section Tx 26-2 signals that contain IDLE signals or ARBx signals as part of the FC signal frames, via the Rx 27-2 and the multiplexer 13-2 of the port bypass circuit 5-2.

As a result of this, whether the FC signal frames sent contain any IDLE signals or ARBx signals can be determined by the error sensor device within each of the magnetic disk devices that is the target of a write operation, and whether a data error occurred in the FC loop can be found by checking cyclic redundancy check bits (CRC) attached to the frames. Furthermore, the magnetic disk device that caused an error in data discrimination can be identified by tracing upstream of a plurality of magnetic disk devices that detected the error.

<Offset Voltage, Data Cycle and Clock>

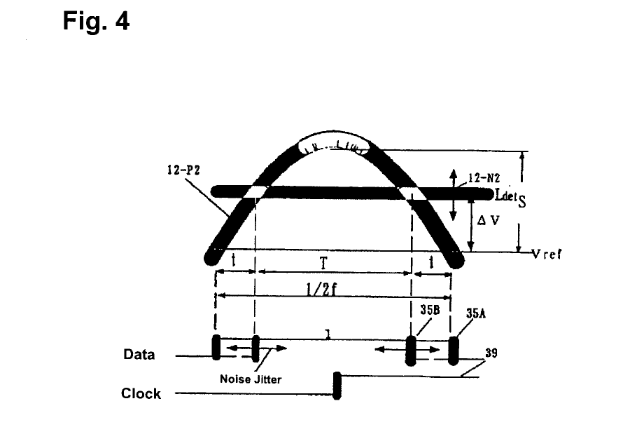

FIG. 4 indicates the relationship among the ΔV offset voltage applied between input terminals of the Rx 27-1 or 27-2 of a port bypass circuit, data cycle T of logical value “1” in the output FC signal (35B or 37B), and a clock 39 that a data recovery circuit of a magnetic disk device takes in. For the sake of simplification, the positive FC differential signal to which the reference voltage Vref in FIG. 3 is provided is called 12-P2, while the negative FC differential signal to which the threshold voltage level Ldet that has been offset by ΔV against the reference voltage Vref is called 12-N2.

Here, the minimum amplitude of an FC differential signal that includes noise jitter and reflection of the positive FC differential signal 12-P2 is S; the data cycle of the logical value “1” is ½f; and the maximum threshold level that includes noise jitter and reflection of the negative FC differential signal 12-N2 that has been offset by ΔV is Ldet.

When the data cycle width of the logical value “1” in the FC signal 35B that was compared and converted into a digital signal by the receiver amplifying section 27-1 is expressed as T, the following relationships are established:

S×sin 2πf=Ldet (1)

t=1/(2πf)sin⁻¹*Ldet/S (2)

Consequently, the receiver amplifying section 27-1 outputs the FC signal in which the data pulse width of the logical value “1” is T=½f−2t when ΔV offset voltage is supplied. In contrast, the data pulse width of the logical value “1” of the digital FC signal 35A is ½f when the ΔV offset voltage is not supplied.

Each of the data cycles of the logical values “11” that are provided as outputs from the receiver amplifying sections 27-1 and 27-2 is virtually proportional to the value of the threshold level Ldet, and therefore the data cycle of the logical value “1” of the FC signal can be made narrower.

Let us consider performing an accelerated test on a device's window margin to take in data.

When a magnetic disk device whose operation margin of the interface with an FC loop is narrow is installed, supplying the ΔV offset voltage makes the data cycle T of the logical value “1” narrow, which causes to narrow the width in which to provide the FC signal 35B, and this in turn makes it impossible to secure a discriminating margin for the clock 39's window to take in data (see FIG. 4). In this way, a data discrimination error can be generated.

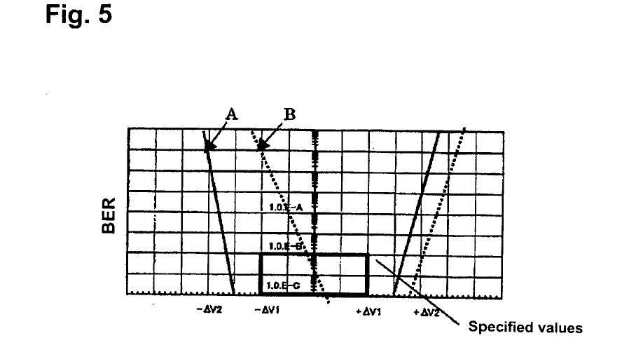

FIG. 5 shows the relationship between the DC offset voltage ΔV applied to the FC differential signals and byte error rate incidence (BER) of magnetic disk devices connected to the FC loop, where the x-axis is the DC offset voltage ΔV and the y-axis is the byte error rate incidence. In FIG. 5, a mark A indicates a packet operation margin of a magnetic disk device in which the FC loop operation margin is secured, and a mark B indicates a packet operation margin of a magnetic disk device in which sufficient operation margin cannot be secured due to an unbalanced packet curve in the FC loop.

The byte error rate is an index of reproducing operation margin, and is a ratio calculated based on the number of error frames detected by a DKA 2 and the number of frames processed (e.g., 520 bytes) by the DKA 2. Besides these, signals that can be used to test the operation margin are drive check codes (sense codes), for example, provided by magnetic disk drives, which can be used to test write operation margin.

The packet operation margin of the magnetic disk device indicated by the mark B is asymmetrical. In the case indicated by the mark B, the byte error rate of 1.0 E-B or lower cannot be secured when the offset voltage is −ΔV1.

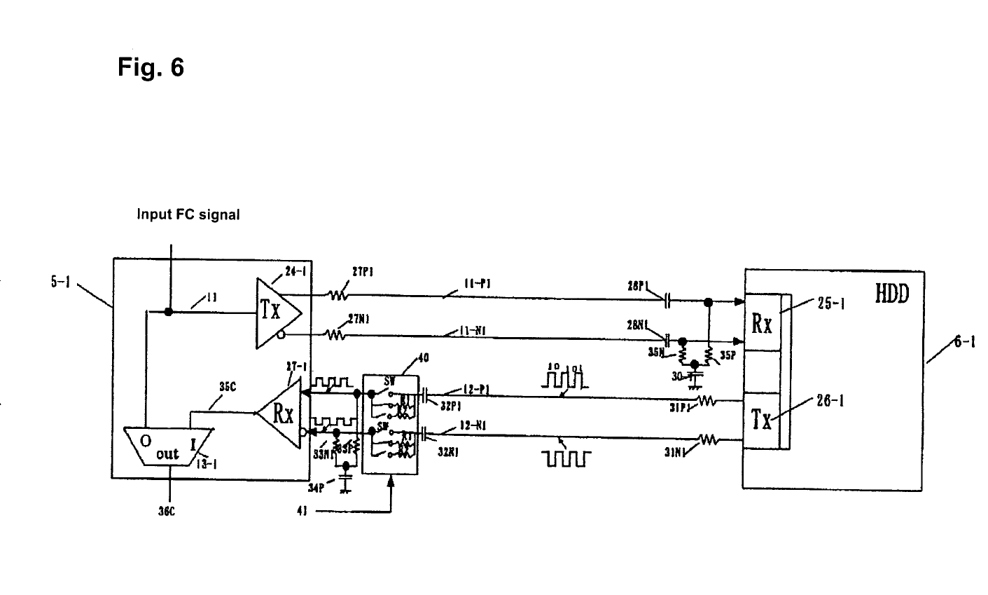

FIG. 6 shows a second embodiment of the present invention.

A loop operation margin test of amplitude values can be performed by providing input terminals of a receiver amplifying section 27-1 with a resistance module element 40 that can change the amplitude of FC signals and using a resistance switching control line 41 to alter the amplitude of digital signals that are transmitted over the FC. Alternatively, FC signals can be DC-offset by applying AM signals instead of a threshold level Ldet.

Instead of the resistance module element 40, a video amplifier can be connected; the thermal noise generated from the video amplifier output is applied to the FC signal lines, and the video amplifier's amplitude gain is made variable. By doing this, the byte error rate incidence (BER) of magnetic disk devices against the S/N ratio of the FC signal (increase jitters in FC signals) can be tested by varying the thermal noise volume generated from the video amplifier output.

<Margin Testing Methods>

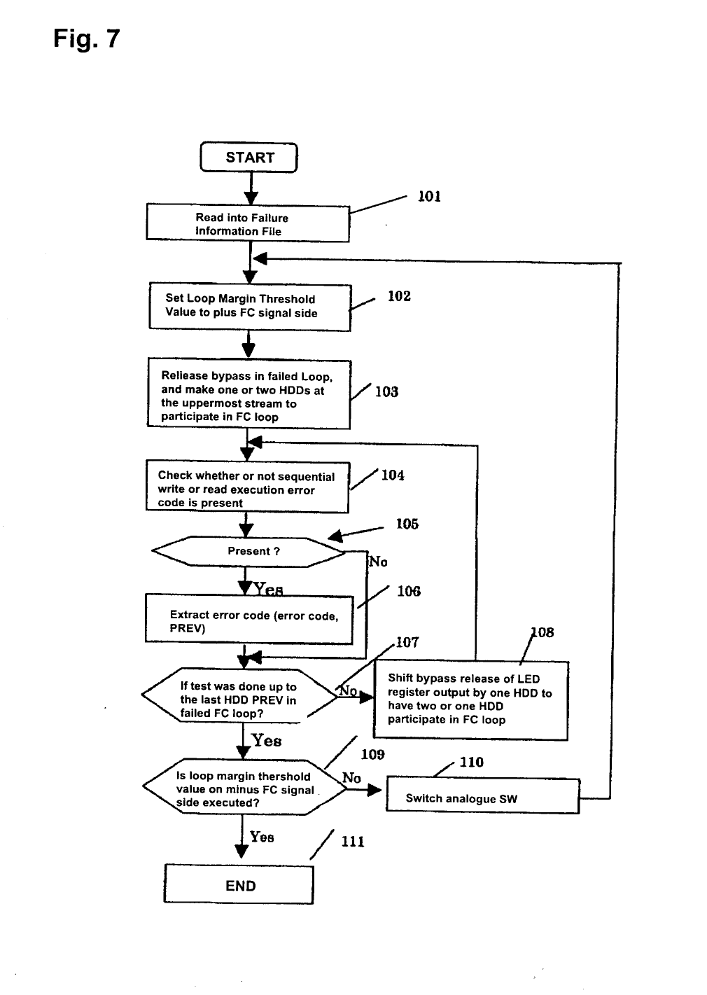

FIG. 7 is a flowchart of a margin test on FC loop interfaces and an example of a method to identify a device with failure when there is a failure.

A precondition for a system that includes a host device 1 and an FC-AL governed by the host device 1 is that when the power is turned on, the system is normally in operation without stopping. In this state, devices of the system including the host device 1 are in an operative state.

A configuration information file is searched in control information files of the host device 1, and the bus and error codes of the device in which the failure occurred are obtained (101). The threshold level Ldet information that has been set in advance by the host device 1 is taken into a microprocessor and the threshold level Ldet is supplied to a signal line 21-P, while a reference voltage Vref is supplied to a signal line 21-N (102).

The bypass in the loop with the failure is released from the failure information obtained, and one or two magnetic disk devices or other devices that are positioned upstream in the loop of the device connected to the FC loop with the failure are assembled into the FC loop (103). In the step, which of the three routines described below should be executed is selected based on the error code information, and the selected routine is executed (104).

Routine 1: Only two magnetic disk devices (or other devices) upstream of the device in which the error was detected are assembled into the loop so that only they would function in the FC loop. The FC signal that bypassed all of the magnetic disk drives or other devices except the magnetic disk devices or other devices that were assembled into the system is sequentially written on downstream magnetic disk devices by allowing the margin testing device to function. Through this, a digital signal can be transmitted in the loop being tested, which makes it possible to run a margin test on a so-called through circuit function (transparency) of the device.

Routine 2: Only one magnetic disk device is assembled into the FC loop, a sequential writing is executed on the magnetic disk device, and a margin test is performed on the write function.

Routine 3: Only one magnetic disk device is assembled into the FC loop, a device to perform a margin test on the FC signal read from the magnetic disk device is allowed to function, and a margin test is executed on a reproducing circuit of the magnetic disk device.

The details of these three routines are described later.

After executing one of the three routines (104), whether there is any error information is tested (105).

If error information is detected, the information is extracted, and the FC loop with the error and the physical address (PREV position) of the magnetic disk device are output to a system log (SySlog) observing monitor screen and stored (106).

If there is no error information, the next magnetic disk device or other device is functionally linked to the FC loop (+1 to PREV of the magnetic disk device) and the routine described above is executed.

If the above routine has not been completed on all of the magnetic disk devices and other devices connected to the FC loop, the following is repeated for each of the magnetic disk devices and other devices (107, 108): a) functionally link each magnetic disk device to the loop; b) execute read/write operations; and c) separate the magnetic disk device from the loop.

Whether the routine described above has been executed on all of the magnetic disk devices and other devices connected to the FC loop with the failure is checked (109); if the routine has not been executed on all, the threshold level is switched to −ΔV (110) and the above routine is executed.

After checking for errors in an accelerated margin test in this way and if any errors are found in the FC signal, the error information is extracted and is provided as an output to the FC-AL failure information file. If there are no errors, there is no extraction or output of error information.

If a failure has occurred, the failure information file and the position information PREV of the magnetic disk device with the failure are obtained, the magnetic disk device in question is separated from the loop, a recovery process for the failure is executed, and the process ends (111).

The FC-AL margin test procedure can be made into a program and stored in a semiconductor memory or other memory media to be executed when a system with an FC-AL is turned on or when a failure is detected.

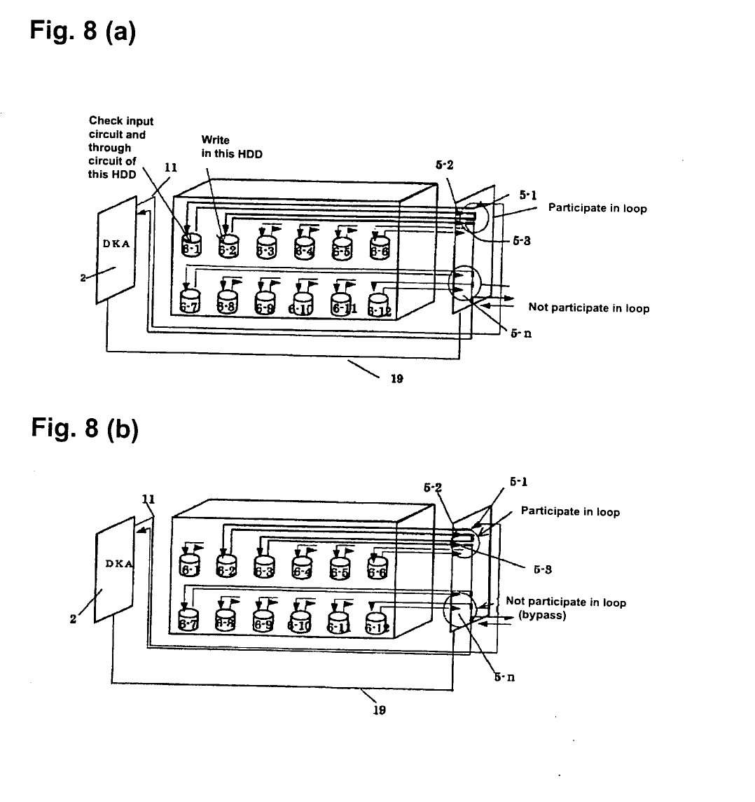

Specific embodiments of the three routines mentioned above are described using FIGS. 8-10.

FIGS. 8(a) and 8(b) are embodiments of a margin test on FC signal's through circuit function in routine 1 in FIG. 7. In FIG. 8(a), an LED bus signal 19 releases the bypass state of port bypass circuits 5-1 and 5-2, and two magnetic disk devices whose physical addresses are 6-1 and 6-2 are made to participate in the FC loop. Remaining port bypass circuits 5-3-5-n are set in a bypass mode, so that magnetic disk devices 6-3-6-12 are not allowed to participate in the FC loop (no participation).

An FC signal 11 sent from a DKA 2 is supplied to the magnetic disk device 6-1 via the port bypass circuit 5-1. The magnetic disk device 6-1 uses its internal through circuit, which consists of, among others, a 10B/8B conversion circuit and a Loss Sync circuit, to detect 10B/8B conversion code errors and Loss Sync errors. If an error is detected, the part where the error was found in FC signal frames is replaced with an IDLE signal or an ARBx signal, and the FC signal is sent to the port bypass circuit 5-2 as a transmitter amplifier output signal via an 8B/10B conversion circuit.

If there are any IDLE signals or ARBx signals in the frames of the FC signal received by the magnetic disk device 6-2 via the port bypass circuit 5-2, the magnetic disk device 6-2 recognizes in the write process onto the magnetic disk device that there is an abnormality in the FC signal received; since the magnetic disk device 6-2 detects the fault error, it can be recognized that an error has occurred in a through circuit of a magnetic disk device upstream of the magnetic disk device 6-2.

In this test, the only upstream magnetic disk device is the magnetic disk device 6-1, and it is recognized that the margin of the through circuit of the magnetic disk device 6-1 is small. This series of processing is sequentially executed on each of the magnetic disk devices connected to the FC loop, as shown in FIG. 8(b). In other words, by using the LED bus to control the port bypass circuits to be sequentially participating/non-participating, the series of processes is executed as the magnetic disk devices that participate in the FC loop are shifted one at a time in pairs until the margin test is completed on all of the magnetic disk devices, and whether there is any error information is checked.

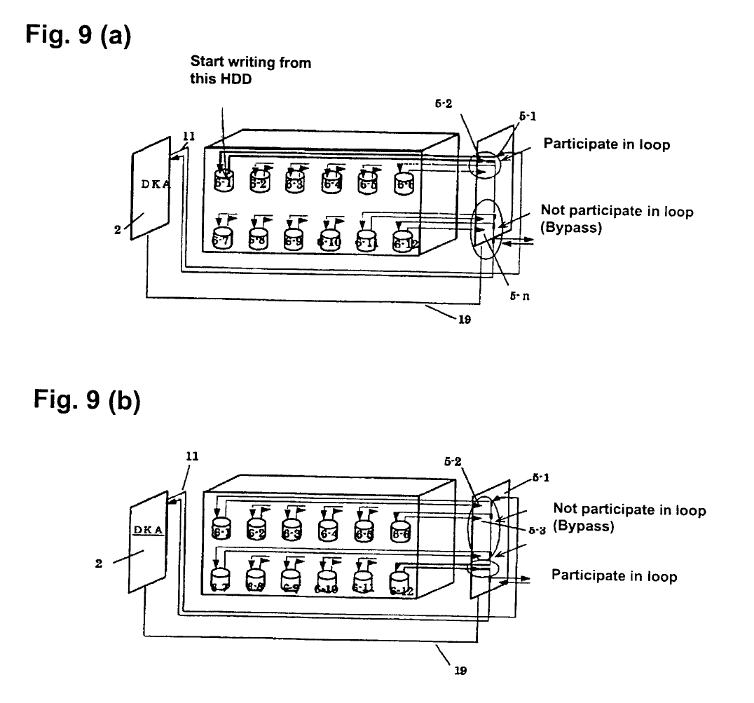

FIGS. 9(a) and 9(b) are embodiments of a margin test on the write function in routine 2 in FIG. 7.

In FIG. 9(a), an LED bus signal 19 releases the bypass state of only a port bypass circuit 5-1, and one magnetic disk device whose physical address is 6-1 is made to participate in the FC loop; a port bypass circuits 5-2-5-n are set in a bypass mode, so that magnetic disk devices 6-2-6-12 are set not to participate in the FC loop.

An FC signal 11 sent from a DKA 2 is supplied to the magnetic disk device 6-1 via the port bypass circuit 5-1. The magnetic disk device 6-1 uses its 10B/8B conversion circuit to convert the FC signal from 10 bytes into 8 bytes. Thereafter, if an error is detected in any FC frame in the write process onto the magnetic disk device 6-1, it is recognized that the write circuit margin of the magnetic disk device 6-1 is narrow. In this test, information writing begins with the magnetic disk device 6-1 and sequentially connects to the downstream devices 6-2, 6-3 . . . in turn, and ends the test with the magnetic disk device 6-12. In other words, by using the LED bus to control the port bypass circuits to be sequentially participating/non-participating, the process is executed as the magnetic disk device that participates in the FC loop is shifted one at a time until the process is conducted on all of the magnetic disk devices, and whether there is any error information is checked.

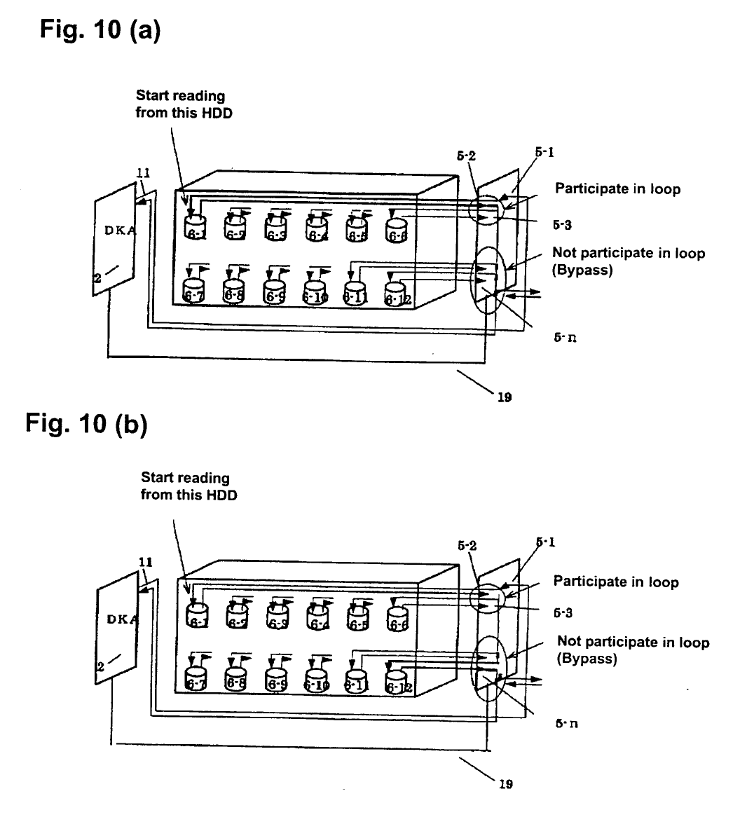

FIGS. 10(a) and 10(b) are embodiments of a margin test in routine three in FIG. 7.

An LED bus signal 19 releases the bypass state of only a port bypass circuit 5-1, and one magnetic disk device whose physical address is 6-1 is made to participate in the FC loop; port bypass circuits 5-3-5-n are set in a bypass mode, so that magnetic disk devices 6-3-6-12 are set not to participate in the FC loop.

An FC signal 11 read from the magnetic disk device 6-1 is sent to a DKA 2 via a port bypass circuit 5-2. The DKA 2 executes a margin test on the read FC signal of the magnetic disk device 6-1 by checking the frame count and other parameters of the FC signal read from the magnetic disk device 6-1. In this test, information reading (read operation) begins with the magnetic disk device 6-1, and the test is executed on devices downstream in the loop one at a time and ends with the magnetic disk device 6-12, as shown in FIG. 10(b).

In other words, by using the LED bus to control the port bypass circuits to be sequentially participating/non-participating, the process is executed as the magnetic disk device that participates in the FC loop is shifted one at a time until the read test is completed on all of the magnetic disk devices, and whether there is any error information is checked.

[Effect of the Invention]

Even if an error were to occur intermittently in magnetic disk devices and other devices downstream of a device with a failure in a loop, the location of the failure can be identified. Consequently, the recovery work can be made more efficient.

By performing an accelerated margin test on interfaces of devices connected to a loop, potentials for failures can be eliminated, which can secure a consistent quality throughout the loop. For example, by using a margin test according to the present invention to remove from a system structure in advance a magnetic disk device with poor sending/receiving breakdown strength that can potentially cause frame count errors as a result of changes in operating environment, the possibility of the FC loop blocking in the client environment can be reduced.

A reduction in loop margin as a result of replacing devices, e.g., magnetic disk devices, connected to the loop can be easily prevented.

If there is a magnetic disk device or another device whose interface margin is narrow among devices connected to a fiber channel loop, the problematic magnetic disk device or another device can be detected and separated or removed.

Quality throughout the loop can be maintained, and loop failures caused by environmental changes such as a temporary increase in exogenous noise can be prevented.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A device that is connected to a fiber channel arbitrated loop, the device comprising:
a port bypass circuit that enables to separate the device from the fiber channel arbitrated loop;
a margin test circuit added to an input/output circuit of the device connected to the port bypass circuit; and
a signal line that provides a control signal to the margin text circuit from outside of the device,
wherein the device is operated on the fiber channel arbitrated loop while the margin test circuit is made functional by the control signal to generate an error.

2. A device according to claim 1, wherein the margin test circuit has a function to modify a duty factor of a digital signal transmitted on the fiber channel arbitrated loop.

3. A device according to claim 1, wherein the margin test circuit has a function to modify an amplitude of a digital signal transmitted on the fiber channel arbitrated loop.

4. A device according to claim 1, wherein the fiber channel arbitrated loop forms a differential signal transmission path, and the margin test circuit has a function to apply a voltage to the differential signal transmission path.

5. A margin test method for a device that is connected to a fiber channel arbitrated loop and has a margin test circuit added to an input/output circuit thereof, the method comprising:
a first step of making effective the device connected to the fiber channel arbitrated loop, a system controlling the device, and a host device that is connected to the device and the system in an accessibly manner;
a second step of setting a margin with the margin test circuit of the device;
a third step of transmitting a digital signal on the fiber channel arbitrated loop;
a fourth step of generating a signal that indicates an error by the device; and
a fifth step of recognizing the signal that indicates an error by the system.

6. A margin test method according to claim 5, wherein the signal that indicates an error recognized by the system is a byte error rate of the device.

7. A method for specifying a failure location in a system having devices connected to a fiber channel arbitrated loop, each of the devices having a margin test circuit added to an input/output circuit thereof, the method comprising:
a first step of bypassing a device from the fiber channel arbitrated loop;
a second step of obtaining information of a path of the device and failure information including error code of the device by the system;
a third step of relieving a state of bypassing the device and assembling one or two of the devices located upstream in the loop as viewed from the bypassed device into the fiber channel arbitrated loop;
a fourth step of operating the margin test circuit to test whether or not there is an error in an input circuit or an output circuit of the devices assembled in the fiber channel arbitrated loop, and storing a result of the test; and
a first step of separating the devices that have been subject to the test from the fiber channel arbitrated loop, and assembling other of the devices in the fiber channel arbitrated loop.

8. A method for specifying a failure location in a system according to claim 7, wherein the step of operating the margin test circuit includes transmitting to the one or two of the devices in the third step a digital signal whose duty factor or amplitude is modified.

9. A method for specifying a failure location in a system having devices connected to a fiber channel arbitrated loop, each of the devices having a margin test circuit added to an input/output circuit thereof, the method comprising:
a first step of turning on a power of the system having the fiber channel arbitrated loop to effectuate the devices;
a second step of connecting one or two of the devices to the fiber channel arbitrated loop, and bypassing other ones of the devices from the fiber channel arbitrated loop;
a third step of, when one device is connected to the fiber channel arbitrated loop in the second step, conducting a margin check for the one device, and of, when two devices are connected to the fiber channel arbitrated loop in the second step, conducting a margin check between the devices that are connected to the fiber channel arbitrated loop; and
a fourth step of, when one device is connected to the fiber channel arbitrated loop in the second step, connecting another device different from the connected device to the fiber channel arbitrated loop instead of the connected device, and of, when two devices are connected to the fiber channel arbitrated loop in the second step, connecting a pair of different ones of the devices different from the connected pair of the devices to the fiber channel arbitrated loop instead of the connected pair of the devices, to conduct a margin check.

10. A method for specifying a failure location in a system according to claim 9, wherein the fourth step includes connecting at least one different device that is located upstream with respect to a flow of information that is transmitted on the fiber channel arbitrated loop.

11. A method for specifying a failure location in a system according to claim 9, further comprising the step of storing a result of the margin check on the device connected to the fiber channel arbitrated loop or a result of the margin check on the devices connected to the fiber channel arbitrated loop.

12. A method for specifying a failure location in a system having devices connected to a fiber channel arbitrated loop, each of the devices having a margin test circuit added to an input/output circuit thereof, the method comprising:
a first step of turning on a power of the system having the fiber channel arbitrated loop to effectuate the devices;
a second step of connecting one of the devices to the fiber channel arbitrated loop, and bypassing other ones of the devices from the fiber channel arbitrated loop;
a third step of conducting a margin check for the one device that is connected to the fiber channel arbitrated loop in the second step, and conducting a margin check for the one device; and
a fourth step of connecting another device different from the device connected to the fiber channel arbitrated loop in the second step, and conducting a margin check for the other device.

13. A method for specifying a failure location in a system according to claim 12, wherein the fourth step includes connecting the different device that is located upstream with respect to a flow of information that is transmitted on the fiber channel arbitrated loop.

14. A method for specifying a failure location in a system according to claim 12, further comprising the step of storing a result of the margin check conducted on the device connected to the fiber channel arbitrated loop.

15. A method for specifying a failure location in a system having devices connected to a fiber channel arbitrated loop, each of the devices having a margin test circuit added to an input/output circuit thereof, the method comprising:
a first step of turning on a power of the system having the fiber channel arbitrated loop to effectuate the devices;
a second step of connecting two of the devices to the fiber channel arbitrated loop, and bypassing other ones of the devices from the fiber channel arbitrated loop;
a third step of conducting a margin check between the devices that are connected to the fiber channel arbitrated loop; and
a fourth step of connecting a pair of two different ones of the devices instead of the connected pair of the devices to the fiber channel arbitrated loop, and conducting a margin check on the pair of two different ones of the devices.

16. A method for specifying a failure location in a system according to claim 15, wherein the pair of two different devices are located upstream with respect to a flow of information that is transmitted on the fiber channel arbitrated loop.

17. A method for specifying a failure location in a system according to claim 15, further comprising the step of storing a result of the margin check conducted on the devices connected to the fiber channel arbitrated loop.

18. A method for conducting a margin test in a system having a plurality of devices connected to a fiber channel arbitrated loop, each of the devices having a margin test circuit added to an input/output circuit thereof, the method comprising the steps of:
inputting a test signal into the fiber channel arbitrated loop;
making a margin more stringent on one of the devices;
detecting an error rate of the one of the devices;
selecting one or two devices from among the plurality of devices to be connected to the fiber channel arbitrated loop;
changing selection of one or two devices to be connected to the fiber channel arbitrated loop upstream or downstream with respect to data transmission in the fiber channel arbitrated loop;
determining which device has a failure; and
separating the determined device from the fiber channel arbitrated loop.

19. A method for conducting a margin test according to claim 18, wherein the step of determining includes presuming which device has a failure.

20. A method for conducting a margin test according to claim 18, wherein the step of determining includes identifying a device with a falling margin.
